(19) United States
(12) Patent Application Publication
(10) Pub. No.: US 2026/0169294 A1
(43) Pub. Date: Jun. 18, 2026

(54) COSMETIC CONTRAST UNIFORMITY IN REFLECTIVE WAVEGUIDES

(71) Applicant: GOOGLE LLC, Mountain View, CA (US)

(72) Inventors: Jun Yang, Mountain View, CA (US); Alexander Koshelev, Kirkland, WA (US); Christophe Peroz, Zollikon (CH)

(21) Appl. No.: 19/422,602

(22) Filed: Dec. 17, 2025

Related U.S. Application Data
(60) Provisional application No. 63/735,128, filed on Dec. 17, 2024.

(51) Int. Cl. G02B 27/01; G02B 1/10; G02C 7/08

(52) U.S. Cl. CPC G02B 27/0172; G02B 1/10; G02C 7/086; G02B 2027/013; G02B 2027/0178; G02C 2202/16

(57) ABSTRACT

A reflective waveguide includes a substrate and a plurality of semi-transparent louver mirrors disposed within the substrate. The reflective waveguide further includes a coating disposed on at least a portion of the substrate and aligned with one or more regions of the substrate without the semi-transparent louver mirrors. The coating has a light transmission characteristic matching a light transmission characteristic of the semi-transparent louver mirrors so as to reduce contrast between one or more regions of the substrate containing the semi-transparent louver mirrors and the one or more regions of the substrate without the semi-transparent louver mirrors. The coating can be disposed at one or more regions of at least one external surface of the substrate. Alternatively, the substrate can include a first workpiece joined with a second workpiece, and the coating is disposed at one or more regions of an interface between the first workpiece and the second workpiece.

### CROSS-REFERENCE TO RELATED APPLICATIONS

The present application is a non-provisional conversion of, and claims priority to, U.S. Provisional Patent Application Ser. No. 63/735,128, entitled “Cosmetic Transparency Uniformity in AR/MR Displays Using Reflective Waveguides” and filed on Dec. 17, 2024, the entirety of which is incorporated by reference herein.

### BACKGROUND

Reflective waveguides find frequent use as optical combiners in augmented reality (AR) and mixed reality (MR) displays. The reflective waveguides utilize semi-transparent louver mirrors to gradually out-couple display light, providing a large eyebox, while also allowing light from the surrounding environment to reach the user's eye, and vice versa. One advantage of the louver mirrors is that they directionally guide the light towards the user's eye with minimal light leakage (e.g., “eyeglow”) to outside observers. Additionally, the non-dispersive nature of louver mirrors, compared to diffraction gratings as found in diffractive waveguides, results in much higher color uniformity across the waveguide and higher overall efficiency or brightness.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is an external observer's perspective of an untreated lens element comprising a reflective waveguide having an extended pupil expander (EPE) and outcoupler (OC) composed of partially-reflective louvered mirrors in accordance with embodiments.

FIG. 2 is a perspective view of a cosmetic coating as would be applied to the lens element of FIG. 1 to generate a treated lens element in accordance with embodiments.

FIG. 3 is an external observer's perspective view of the treated lens element resulting from application of the cosmetic coating of FIG. 2 to the untreated lens element of FIG. 1 to generate a treated lens with reduced observable contrast between mirrored regions and non-mirrored regions in accordance with some embodiments.

FIG. 4 is a cross-section view of a reflective waveguide with a cosmetic coating applied at an interface between two adjoined workpieces to provide reduced observable contrast between mirrored regions and non-mirrored regions in accordance with some embodiments.

FIG. 5 is a cross-section view of a reflective waveguide with a cosmetic coating applied at one or more external surfaces of the reflective waveguide to provide reduced observable contrast between mirrored regions and non-mirrored regions in accordance with some embodiments.

FIG. 6 is a cross-section view of a lens system with a reflective waveguide and one or more adjacent lens elements having a cosmetic coating to provide reduced observable contrast between mirrored regions and non-mirrored regions in accordance with some embodiments.

FIG. 7 is a cross-section view of a reflective waveguide with color-doped regions to provide reduced observable contrast between mirrored regions and non-mirrored regions in accordance with some embodiments.

FIG. 8 is a view of a lens element with a reflective waveguide with an interstitial region in accordance with some embodiments.

FIG. 9 is a diagram illustrating a rear perspective view of a near-eye display (NED) device implementing cosmetic coatings for reduced contrast in an implemented reflective waveguide in accordance with some embodiments.

### DETAILED DESCRIPTION

Widespread adoption of AR/MR glasses or other eyewear display devices depends on the ability to provide a cosmetically attractive appearance, typically by appearing as similar as practicable to regular eyewear. This includes the overall form factor (including size, proportions, and weight), but also the absence of any significant visual artifacts from both the user's point of view, as well as from the bystander's point of view. In other words, designers of eyewear display devices generally seek to have such devices appear like regular eyewear.

For reflective waveguides, their semi-transparent mirrors typically result in a reduction of the see-through transmission. The incident light from the world is coupled into the waveguide through the same mechanism as light in the waveguide is coupled out. For example, if the out-coupling efficiency of these mirrors is, for example, 15%, then the see-through transmission will be no greater than 85%. This results in noticeable contrast between the mirrored regions and the non-mirrored regions of the reflective waveguide from a bystander's point of view.

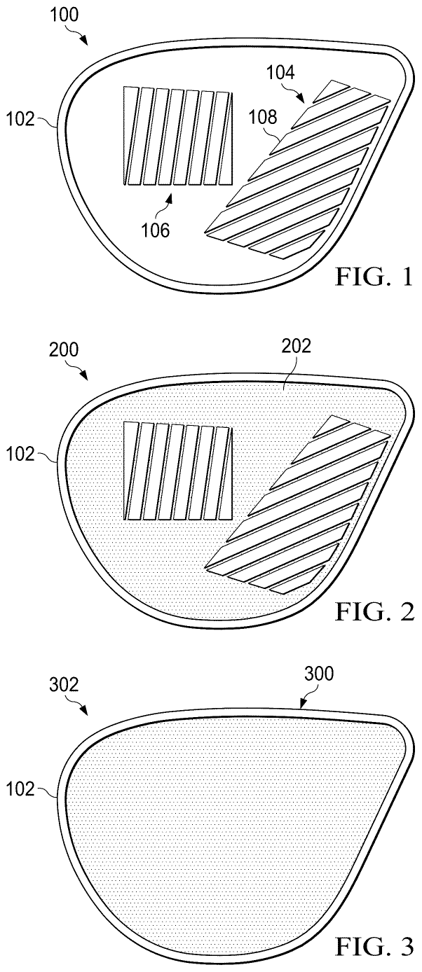

To illustrate, FIG. 1 depicts a front view of a lens element 100 for use in AR/MR glasses, with the lens element 100 having an eyewear lens form factor and comprising a substrate 102 in which a reflective waveguide is formed. The substrate 102 may be composed of, for example, one or more plastics or other polymers. The reflective waveguide has an incoupler (IC)(not shown), an exit pupil expander (EPE) 104, and an outcoupler (OC) 106, with at least the EPE 104 and OC 106 implemented with semi-transparent louver mirrors (e.g., louver mirror 108). Due to the semi-transparent nature of the louver mirrors, the EPE 104 and OC 106 will exhibit a different contrast compared to the rest of the substrate 102.

To address these issues, FIGS. 2-8 below illustrate approaches to improve the overall cosmetics of eyewear devices utilizing reflective waveguides, such as the lens element 100 of FIG. 1, by reducing the contrast between the mirror regions and non-mirror regions, such that the louver mirrors are less visible by comparison. In some embodiments, a cosmetic thin film coating can be applied in the non-mirror regions of the reflective waveguide in order to, in effect, “equalize” the loss of transmission of the reflective coating on the active mirror regions. This equalization could be realized through net absorption, color matching, and the like, such the coating has a light transmission characteristic substantially matching a light transmission characteristic of the semi-transparent louver mirrors (e.g., in color, in luminance, or both).

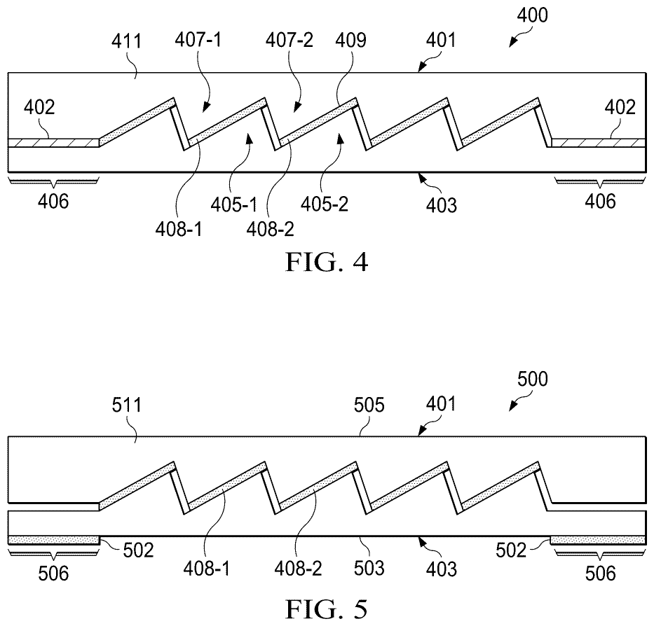

FIG. 2 depicts a world-side view 200 of an example of this approach with reference to the substrate 102 of FIG. 1. As depicted, one or more cosmetic coatings 202 is formed by deposition or other application to the substrate 102 such that coating material(s) of the one or more cosmetic coatings 202 substantially align with regions where the mirrors of one or more of the EPE 104 or OC 106 are absent (hereinafter “non-mirror” regions), from the perspective of an external observer, and are substantially absent from the regions where such mirror are present (hereinafter, “mirror” regions), again from the perspective of an external viewer. That is, viewing the world side of the resulting one or more cosmetic coatings 202 relative to the shape of the substrate 102, the one or more cosmetic coatings 202 are effectively present or otherwise aligned wherever the mirrors of one or both of the EPE 104 or the OC 106 are not. As described in greater detail below with reference to FIGS. 4-7, this can be achieved by one or more of disposing or otherwise applying the coating material(s) in the non-mirror regions of one or both interface surfaces of two adjoining workpieces forming the lens element in which the reflective waveguide is formed, disposing or otherwise applying the coating material(s) to one or both external surfaces of the lens element, applying the coating materials to a surface of one or more adjacent lens elements (e.g., a corrective lens), by color doping one or more non-mirror regions of the substrate forming the lens element, or a combination of two or more of these approaches.

The one or more cosmetic coatings 202 can be selected to match the transmission and/or the color of the semi-transparent mirror coatings of the mirrors of the EPE 104 and/or IC 106 across the lens element and across different viewing angles. The cosmetic coatings can also be selected so as to have minimum reflection. For example, in some embodiments, the coating materials may be selected to meet the following criteria: ΔT=|T_mirror−T_cosmetic|<0.5%; and R_cosmetic<0.5% over a 120-degree horizontal viewing angle and 40 degree vertical viewing angle, and duv=u′v′_mirror−u′v′_cosmetic|<0.002. In other embodiments, a more relaxed range would include the following criteria: ΔT=T_mirror−T_cosmetic|<5%; and R_cosmetic<1%, and duv=|u′v′_mirror−u′v′_cosmetic|<0.005 over 90 degree horizontal viewing angle and 40 degree vertical viewing angle. Further, in some embodiments, the one or more cosmetic coatings 202 can have spatially varying transmission to better match the active mirror coatings in different regions.

FIG. 3 illustrates a view 302 of a resulting modified lens element 300 from the perspective of a world-side observer. With the one or more cosmetic coatings 202 substantially matching the transmission and/or color of the semi-transparent mirrors (e.g., mirror 108) of the EPE 104 and OC 106, the world-side view 302 of the modified lens element 300 effectively presents a uniform color and consistency, with the visibility (contrast) of the outlines of the mirrored regions of the EPE 104 and OC 106 significantly reduced compared to the conventional uncoated approach as represented by the untreated lens element 100 of FIG. 1.

FIGS. 4-7 illustrate example approaches for applying cosmetic coatings to a lens blank employing a reflective waveguide in accordance with various embodiments. Typically, a reflective waveguide having a substrate composed of plastics or other polymers is formed through certain manufacturing techniques, such as injection molding, casting (ultraviolet, thermal, or hybrid). Typically, two individual workpieces representing the world-side and eye-side, respectively, of a reflective waveguide to be formed are molded, cast, shaped, or otherwise formed separately, partially-reflective mirrors are deposited or otherwise formed on corresponding louver surfaces on one of the workpieces, and then the two workpieces are bonded together or otherwise adjoined to form the reflective waveguide.

For example, FIG. 4 illustrates a cross-section view of a reflective waveguide 400 manufactured in this manner, with a world-side workpiece 401 and separate eye-side workpiece 403 formed via molding, casting, milling, or the like. In some embodiments, the workpieces 401 and 403 are formed from one or more plastics or other polymers. The workpiece 403 has a plurality of louvers 405 (e.g., louvers 405-1, 405-2) formed at the world-facing surface, and the workpiece 401 has a corresponding plurality of louvers 407 (e.g., louvers 407-1, 407-2) formed at the eye-facing surface, such that the plurality of louvers 407 are conformal with the plurality of louvers 405 when the workpieces 401, 403 are adjoined. One or more mirror coatings 409 are deposited or otherwise formed at the angled faces of louvers 405 (or alternatively, at the angled faces of louvers 407) to form a plurality of semitransparent louver mirrors 408 (e.g., louver mirrors 408-1, 408-2)(one embodiment of the mirrors 108) when the two workpieces 401, 403 are adjoined. Such coatings can include, for example, a multilayer dielectric coating with partially reflective properties for light at the wavelengths of interest. In a conventional approach, the workpieces 401 and 403 would then be bonded together or otherwise adjoined using optical adhesive, fusion via partial melting, and the like, thereby forming a substrate 411 (one embodiment of substrate 102) of the waveguide 400, with at least the EPE and OC formed from corresponding regions of louver mirrors 408.

However, in the approach depicted in FIG. 4, a cosmetic coating 402 (one embodiment of cosmetic coating 202) is applied to an inner surface of one or both of the workpieces 401, 403 in some or all of the region of the interface between the workpieces 401, 403 in which the louver mirrors 408 are absent (that is, in some or all of the non-mirror regions of the resulting substrate). For example, the cosmetic coating 402 may be applied in a region 406 of the interface between the two workpieces 401, 403 that surrounds, but does not include, an EPE 104 or OC 106 formed by the illustrated louver mirrors 408 and corresponding louvers 405, 407.

FIG. 5 depicts a similar reflective waveguide 500 comprising the two workpieces 401, 403 fused, adhered, or otherwise permanently joined with the plurality of semitransparent louver mirrors 408 formed at their interface to form a substrate 511 (one embodiment of substrate 102) for the waveguide 500. However, in contrast with the reflective waveguide 400, which employs the cosmetic coating 402 at the interface between the two workpieces 401, 403, the waveguide 500 employs a cosmetic coating at one or both external surfaces of the waveguide 500, with the cosmetic coating having a light transmission characteristic (color and/or luminance) substantially matching a light transmission characteristic of the semi-transparent louver mirrors. To illustrate, in the depicted example, the waveguide 500 employs a cosmetic coating 502 (another embodiment of cosmetic coating 202) disposed at the eye-side surface 503 of the reflective waveguide 500, with the cosmetic coating 502 disposed in region(s) of the eye-side surface 503 that align with region(s) of the interface between the two workpieces 401, 403 in which the louvered mirrors 408 are absent (that is, non-mirror regions) and absent in the region(s) of the eye-side surface 503 that align with region(s) of the interface in which the louvered mirrors 408 are present (that is, mirror regions), such as illustrated region 506, which aligns with region 406 of FIG. 4. In other embodiments, the cosmetic coating 502 may be disposed at the world-side surface 505 of the reflective waveguide 500 with the same alignment constraints, or the cosmetic coating 502 may be disposed at a combination of both surfaces 503 and 505.

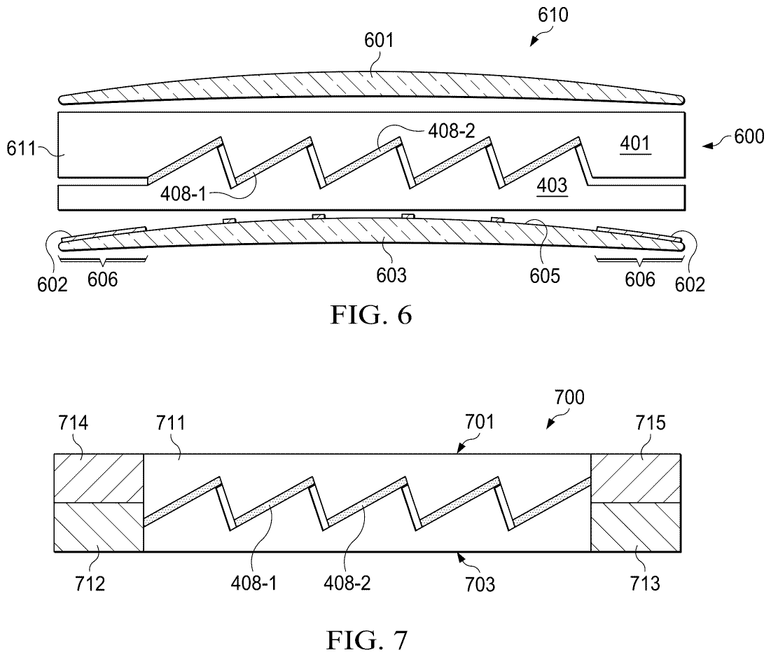

FIG. 6 depicts a cosmetic coating approach for an optical system 610 employing a waveguide 600 along with one or both of a world-side lens 601 disposed adjacent to the world-side surface of the waveguide 600 or an eye-side lens 603 disposed adjacent to eye-side surface of the waveguide 600 (that is, between the waveguide 600 and an expected position of an eye of a user). The waveguide 600, in one embodiment, includes a substrate 611 (one embodiment of substrate 102) formed from the workpieces 401, 403 with one or more regions of partially-reflective mirrors 408 (e.g., 408-1 and 408-2) as described above with reference to FIGS. 4 and 5. The world-side lens 601 and the eye-side lens 603 may comprise, for example, ophthalmic lenses for vision correction, light filtering, special vision effects, and the like. In this approach, rather than, or in addition to, applying a cosmetic coating to the reflective waveguide 600 itself, a cosmetic coating may be applied to one or more surfaces of one or both of the lenses 601, 603. In the depicted example, a cosmetic coating 602 is disposed at the surface 605 of the eye-side lens 603 that faces the substrate 611, with the cosmetic coating 602 disposed in region(s) of surface 605 that align with region(s) of the interface between the two workpieces 401, 403 in which the louvered mirrors 408 are absent and absent in the region(s) of the eye-side surface 503 that align with region(s) of the interface in which the louvered mirrors 408 are present, such as illustrated region 606, which aligns with region 406 of FIG. 4. In other embodiments, the cosmetic coating 602 may be disposed at, for example, the eye-side surface of the eye-side lens 603, the world-side surface of the world-side lens 601, the eye-side surface of the world-side lens 601, or a combination thereof, with the same alignment constraints.

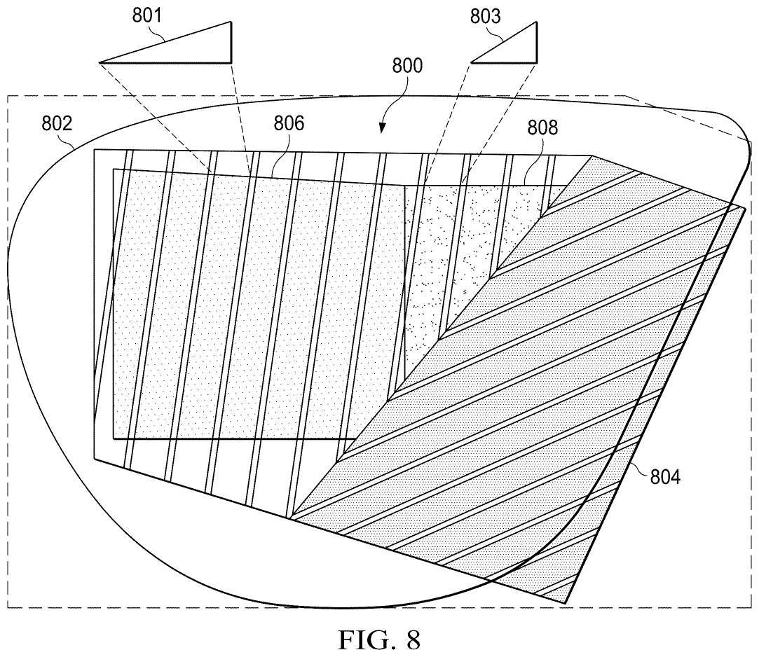

FIG. 7 illustrates an alternative approach in which color doping of the substrate of a reflective waveguide 700 is employed to cosmetically conceal the transition from mirror to non-mirror regions in the waveguide 700 in accordance with embodiments. In the depicted example, the reflective waveguide 700 includes workpieces 701, 703 (similar to workpieces 401, 403) glued, fused, or otherwise joined together to form a substrate 711 (one embodiment of substrate 102), with conformal mirror-coated louvers formed at their interface so as to form the partially reflective louver mirrors 408 (e.g., mirrors 408-1 and 408-2). However, rather than, or in addition to, utilizing a cosmetic coating to camouflage or otherwise conceal from external observers the transition between mirror regions and non-mirror regions (that is, to reduce contrast between one or more regions of the substrate containing the semi-transparent louver mirrors and the one or more regions of the substrate without the semi-transparent louver mirrors), the reflective waveguide 700 instead employs color doping in one or more regions of one or both of the workpieces 701, 703 in which the mirrors 408 are absent (that is, the non-mirror regions). For example, in the depicted embodiment, regions 712 and 713 of the workpiece 701 are color-doped during its fabrication process, as are regions 714 and 715 of the workpiece 703 during its fabrication process. In other embodiments, only one of the workpieces 701, 703 may be color-doped in this way. The color-doping process can include, for example, adding organic disperse dyes through dip dyeing, mass coloration through thermally stable organic dyes, or adding photochromatic molecules.

In still other embodiments, a combination of two or more of the approaches of FIGS. 4-7 can be employed. For example, the process of forming the cosmetic coating 402 at the interface between the two workpieces 401 and 403 may be used for one or more non-mirror regions surrounding the mirror region of the EPE 104, while the process of forming the cosmetic coating 502 at an external surface of at least one of the workpieces 401, 403 may be used for one or more non-mirror regions surrounding the mirror region of the OC 106, or vice versa.

For cosmetic coatings applied inside the waveguide, they can be laterally aligned with the mirror regions. For coatings applied on the exterior of the waveguide or on a separate surface, they can be spatially aligned with the active mirrors to achieve proper compensation. In some embodiments, the coating boundary is within 100 μm (due to human vision resolution) with respect to the mirror coating's boundary. The boundary of the cosmetic coating or the active mirror boundary might also be tapered to relax the alignment requirement and achieve suitable performance for different viewing angles. To illustrate, a flat 15% absorption (as an example) cosmetic coating can be applied to one surface could be employed, a tapered cosmetic coating on both top and bottom surfaces of the waveguide can be employed, or the mirror coating itself of the mirrors 408 can be tapered and the mirrors 408 can be more densely packed. Such a gradation of the cosmetic coating could be realized through different coating designs near the boundary, or through spatial modulation.

The cosmetic coating can be designed to match the transmission and/or the color in the see-through direction when compared against the semi-transparent mirror coating. For example, for mirrors with 85% transmission in the see-through direction, the cosmetic coating can have 15% absorbance in the same direction, while having minimum back-reflection. Table 1 shows an example of such a coating made out of a thin film stack.

TABLE 1

| layer # | material | Refractive index @ 520 nm | physical thickness (nm) |
|---|---|---|---|
| 1 | Polymer | 1.62 | — |
| 2 | Ta2O5 | 2.20 | 9.33 |
| 3 | SiO2 | 1.46 | 26.35 |
| 4 | Carbon | 2.31 + 0.87i | 5.59 |
| 5 | SiO2 | 1.46 | 47.90 |
| 6 | Ta2O5 | 2.20 | 5.02 |
| 7 | SiO2 | 1.46 | 47.47 |
| 8 | Polymer | 1.62 | — |

For cosmetic coatings applied inside or on the surface of the waveguide, for some specific waveguide design layouts, the display light passes through the cosmetic coating region during its propagation from the IC to the OC, which would be associated with a net loss of light efficiency. FIG. 8 depicts a view of a lens 802 with a reflective waveguide 800 in which this net loss of light efficiency may occur. The waveguide 800 includes an exit pupil expander (EPE) 804, an output coupler (OC) 806, and an interstitial region 808. In the conventional case with a more acute mirror angle 801 as found in, for example, the EPE 804 or OC 806, the interstitial region 808 also leads to loss of the optical efficiency of the waveguide—if this region is covered with absorptive coatings, it leads to a loss of optical efficiency of the waveguide; if this region is covered with reflective coatings, it will still lead to unwanted out-coupling of display light, as such light will not arrive at the eyebox. However, if the mirror angle in the interstitial region 808 is adjusted to a less acute angle 803, as illustrated, the design of a reflective coating to match the transmission in the see-through direction while maintaining low loss is easier to facilitate.

To minimize the undesirable efficiency loss, in one approach, the polar angle of this mirror region can be changed, and a different reflective coating applied on the mirror surfaces. Due to the change of this polar angle, the reciprocity condition between the out-coupling and see-through no longer applies. Thus, the design of a reflective coating that has specific see-through transmission, but with minimal out-coupling efficiency, is facilitated. This polar angle and the output coupler coating design can be selected such that the same coating can be applied to the regions of the EPE 804 and OC 806, yet the see-through transmission is similar enough between the two regions, while the display light reflectivity in the interstitial region 806 is reduced. The polar angle of this region might differ from the polar angle in the output coupler region by 5°-30°. The “non-display” prism polar angle in this region can be chosen such that the mirrors reflect the majority of the outside incident angles into waveguide total internal reflection (TIR) directions. For example, such a polar angle can be ˜45°. This helps to ensure the reflection from this region does not appear visible to the outside observer at most viewing angles. Additionally, this ensures that real-world light cannot be redirected towards the user's eye, which would create a rainbow artifact. This prism array structure with the “non-display” polar angle could also be used in other areas of the waveguide instead of the absorptive coating. This prism array structure could be a 2D array of prism elements, such as pyramids.

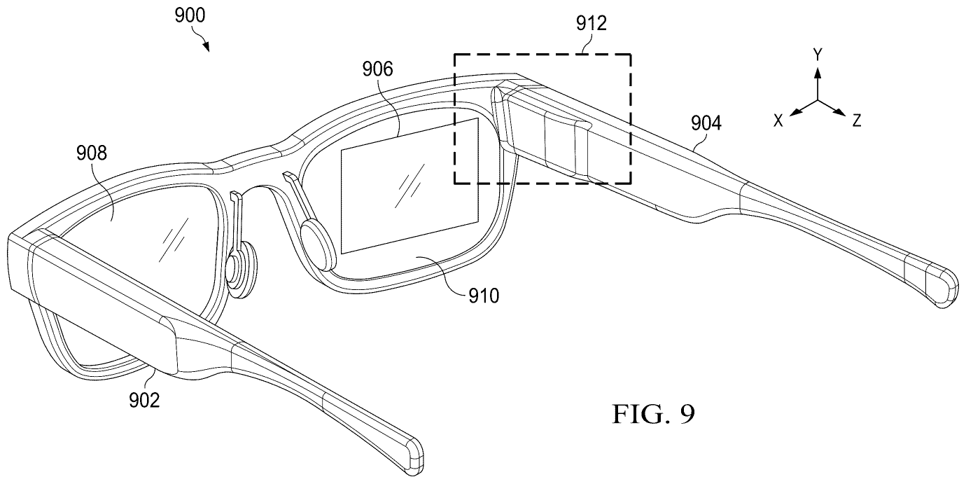

FIG. 9 is a diagram illustrating a rear perspective view of a near-eye display (NED) device 900 implementing cosmetic coatings for reduced contrast in an implemented reflective waveguide in accordance with some embodiments. The NED device 900 includes a support structure 902 (e.g., a support frame) to mount to a head of a user and that includes an arm 904 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 906 at one or both of lens elements 908, 910 supported by the support structure 902. In some embodiments, the support structure 902 further includes various sensors, such as one or more front-facing cameras, light sensors, motion sensors, accelerometers, and the like.

The support structure 902 can further include one or more radio frequency (RF) interfaces or other wireless interfaces, such as a Bluetooth™ interface, a WiFi interface, and the like. The support structure 902 can also include one or more batteries or other portable power sources for supplying power to the electrical components of the NED device 900. In some embodiments, some or all of these components of NED device 900 are fully or partially contained within an inner volume of support structure 902, such as within the arm 904 in region 912 of the support structure 902. In the illustrated implementation, the NED device 900 utilizes an eyeglasses form factor. However, the NED device 900 is not limited to this form factor and thus may have a different shape and appearance from the eyeglasses frame depicted in FIG. 9.

One or both of the lens elements 908, 910 are see-through optical elements incorporating a reflective waveguide with one or more cosmetic coatings as described herein and used by the NED system 900 to provide an AR/MR display in which rendered graphical content can be superimposed over or otherwise provided in conjunction with a real-world view as perceived by the user through the lens elements 908, 910. For example, laser light or other display light is used to form a perceptible image or series of images that are projected onto the eye of the user via one or more optical elements, including a waveguide, formed at least partially in the corresponding lens element. One or both of the lens elements 908, 910 thus includes at least a portion of a waveguide (e.g., one or more of reflective waveguides 200, 400, 500, 600, or 700) employing one or more cosmetic coatings or substrate color doping as described herein, for facilitating the concealment of the contrast between mirror regions and non-mirror regions to an external observer. This waveguide routes display light received by an incoupler (IC) (not shown in FIG. 9) of the waveguide to an outcoupler (OC) (not shown in FIG. 9) of the waveguide, which outputs the display light toward an eye of a user of the NED device 900. Additionally, the waveguide employs an exit pupil expander (EPE) (not shown) in the light path between the IC and OC, or in combination with the OC, in order to increase the dimensions of the display exit pupil. Each of the lens elements 908, 910 is sufficiently transparent to allow a user to see through the lens elements to provide a field of view of the user's real-world environment such that the image appears superimposed over at least a portion of the real-world environment.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified, and all such variations are considered within the scope of the disclosed subject matter. Accordingly, the protection sought herein is as set forth in the claims below.

What is claimed is:

1. A reflective waveguide, comprising:
a substrate;
a plurality of semi-transparent louver mirrors disposed within the substrate; and
a coating disposed on at least a portion of the substrate and aligned with one or more regions of the substrate without the semi-transparent louver mirrors, wherein the coating has a light transmission characteristic substantially matching a light transmission characteristic of the semi-transparent louver mirrors.

2. The reflective waveguide of claim 1, wherein the coating is disposed at one or more regions of at least one external surface of the substrate.

3. The reflective waveguide of claim 1, wherein:
the substrate comprises a first workpiece joined with a second workpiece, and wherein the coating is disposed at one or more regions of an interface between the first workpiece and the second workpiece.

4. The reflective waveguide of claim 1, wherein the coating comprises a thin film stack configured to substantially match one or both of a transmission or a color of the semi-transparent louver mirrors.

5. The reflective waveguide of claim 1, wherein:
the plurality of semi-transparent louver mirrors are arranged as an exit pupil expander, an output coupler, and an interstitial region between the exit pupil expander and the output coupler; and
a polar angle of the semi-transparent louver mirrors of the interstitial region differs from a polar angle of the semi-transparent louver mirrors of the output coupler by at least five degrees.

6. A near-eye display device, comprising:
a support structure configured to be worn on a head of a user; and
a lens element supported by the support structure, the lens element comprising the reflective waveguide of claim 1.

7. The near-eye display device of claim 6, further comprising:
a lens disposed between the reflective waveguide and an expected position of an eye of a user; and
an additional coating disposed on at least one surface of the lens and aligned with the one or more regions of the substrate without the semi-transparent louver mirrors, wherein the additional coating has a light transmission characteristic substantially matching a light transmission characteristic of the semi-transparent louver mirrors.

8. A reflective waveguide, comprising:
a substrate;
a plurality of semi-transparent louver mirrors disposed within the substrate; and
wherein one or more regions of the substrate without the semi-transparent louver mirrors are color doped so as to have a light transmission characteristic matching a light transmission characteristic of the semi-transparent louver mirrors.

9. A near-eye display device, comprising:
a support structure configured to be worn on a head of a user; and
a lens element supported by the support structure, the lens element comprising the reflective waveguide of claim 7.

10. A method of manufacturing a reflective waveguide, comprising:
forming a substrate comprising a plurality of semi-transparent louver mirrors disposed within the substrate; and
applying a coating disposed on at least a portion of the substrate and aligned with one or more regions of the substrate without the semi-transparent louver mirrors, the coating having a light transmission characteristic matching a light transmission characteristic of the semi-transparent louver mirrors.

11. The method of claim 10, wherein applying the coating comprises applying the coating at one or more regions of at least one external surface of the substrate.

12. The method of claim 10, wherein:
forming the substrate comprises joining a first workpiece with a second workpiece; and
applying the coating comprises applying the coating to one or more regions of a surface of at least one of the first workpiece or the second workpiece at an interface between the first workpiece and the second workpiece.

13. The method of claim 10, wherein the coating comprises a thin film stack configured to substantially match one or both of a transmission or a color of the semi-transparent louver mirrors.

14. The method of claim 13, wherein the thin film stack comprises multiple layers of dielectric materials comprising at least one of: silicon dioxide (SiO2), titanium dioxide (TiO2), tantalum pentoxide (Ta2O5), carbon (C), or aluminum oxide (Al2O3).
